(19) United States
(12) Patent Application Publication
(10) Pub. No.: US 2007/0183153 A1
(43) Pub. Date: Aug. 9, 2007

(54) All-in-one LED assembly, string assembly and method

(76) Inventor: Jing Jing Yu, Vancouver (CA)

Correspondence Address: Jing Jing Yu, 8415 Granville Street, Box 87, Vancouver, V6P 4Z9, CA

(21) Appl. No.: 11/350,343

(22) Filed: Feb. 9, 2006

(51) Int. Cl. F21S 13/14

(52) U.S. Cl. 362/252

(57) ABSTRACT

The invention presents a new practical LED assembly and LED string assembly. The invented LED package includes an LED, a lamp cover, a lamp holder, wire connections, and a plug. The LED with its electrical connections is inserted and positioned in the lamp cover/lamp holder subassembly. The bottom opening of the lamp holder and the exit path of the wires are sealed by a plug. Compared to the conventional LED string manufacture procedures using injection modeling, the new assembly uses discrete components that make the LED assembly components standardized and replaceable, and dramatically reduce production cost and improve manufacture efficiency. Because the new assembly structure is tightly attached and hence discouraging any unauthorized removal of the expensive LED lamps from the strings.

### FIELD OF THE INVENTION

The present invention relates to the field of decorative lighting and, more particularly, to light emitting diode (LED) assemblies and LED strings and the method of assembly. Heading

### DESCRIPTION OF RELATED ART

Semiconductor Light emitting diodes (LED) have been widely used as decorative lighting sources, especially on holidays because of their low cost and perfect physical properties including their low operating voltage and power, small sizes, long lifetime and great stability. LEDs are cool light sources without generating heat and thus can operate for long periods of daily operation.

There are two types of lamps used in conventional LED strings: separable lamps and inseparable lamps. In the first type, a LED lamp can be plugged into and unplugged from a string, thus is replaceable. Separable LED lamps can be manufactured separately from the rest of the string and thus allow flexibility in production and assembly. However, all the current packaging assemblies for separable LED strings have drawbacks because the ability to remove the LED makes the individual LED lamps susceptible to theft especially when the LED stings are placed in public areas. In the second type, inseparable LED lamps are fixed on the string. When manufactured, each LED lamp is individually packaged onto a string using injection molding technology and thus has much higher cost associated with the injection molding machines, dies and the necessity to do final assembly of the components at the injection molding machine. Moreover, the current manufacture procedure often damages the LED pins and diode bodies causing loss of materials and quality problems.

To overcome the shortcomings of the above discussed conventional LED string packaging structures, the presented invention provides a new LED and LED string packaging assembly structure and method. On one side, like separable LED strings, all components are manufactured separately, and thus assembly can be more efficient. By having a tight or interference fit packaging procedure, the invented new assembly structure and design has virtually made the individual LED lamps permanently attached to the LED strings, similar to injection molding; and thus deter individual LED lamps from any unauthorized removal.

### DESCRIPTION OF THE DRAWINGS

FIG. 1A shows a LED assembly packaging structure for LED strings, comprising a lamp cover 101, a LED diode body 102, a lamp holder 103, multiple pins (there are two in the example shown in these drawings, but other LEDs may have more), 104 connected with the proper number and polarity with electrical wires suitable for the circuit design 106, the pins and connections may be insulated using commonly available means of insulation to prevent short circuits, and a plug 105 which fits into and seals the bottom opening of the lamp cover and lamp holder sub-assembly.

FIG. 1B shows an alternate embodiment of the lamp cover/lamp holder sub-assembly with the LED in position and held in the proper orientation by a clip 108 within the lamp cover/lamp holder subassembly.

FIGS. 2A and B shows an example of a plug used to fit around the wires and into the bottom opening of the lamp holder with a cut or break, 110.

FIGS. 3A and B shows an example of a plug, without a cut or break, with passageways for the appropriate number of wires.

### DETAILED DESCRIPTION OF THE INVENTION

The individual LED light assembly is made up from the following components. The lamp cover 101 which may be wholly or partially transparent, translucent, or with a pattern as desired. The lamp holder may be a hollow annular ring or cylinder which is chosen of any suitable material that is non-conducting, or that is insulated, having a top opening which matches or fits the opening of the lamp cover and a bottom opening. The fit of the lamp cover and the top opening of the lamp holder is such that the connection substantially seals out moisture and contaminants from gaining access, through this connection, to the inner part of the lamp cover/lamp holder subassembly. This sealing may be by friction interference fit, bonding (thermal, sonic or solvent), injection molding of the assembly, adhesive or filler material. The lamp holder may be of alternate shapes, other than cylindrical, as desired, so long as it has the suitable top to match the lamp cover and a bottom opening to allow the LED diode to be inserted into the lamp cover/lamp holder sub-assembly with the wires exiting to be sealed by the plug. An alternate construction would have the lamp cover and lamp holder be of a single piece, so long as it provided proper function of allowing the LED light to be used and having a bottom opening for the plug as herein disclosed.

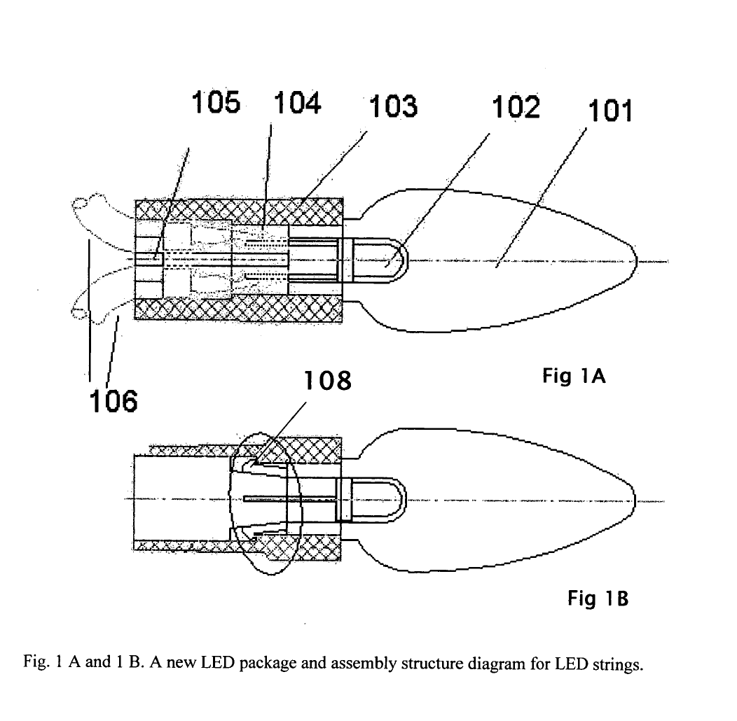

The LED diode body 102 with electrical pins 104 is electrically connected with proper polarity, to electrical wires 106. The LED diode body fits and is held in the lamp cover/lamp holder subassembly, in the proper orientation for light from the LED to shine through the lamp cover, either by mechanical means, such as a position holder or clip 108 as shown in FIG. 1B, such as a friction fit or other mechanical means known in the art, adhesive or other suitable means. The wires 106 are electrically connected to the pins 104 and extend out of the bottom opening of the lamp cover/lamp holder subassembly when the LED diode body is installed in the lamp cover/lamp holder subassembly. When fully assembled the bottom opening is sealed by the plug 105 with the wires exiting through the plug from the lamp cover/lamp holder/LED/plug assembly.

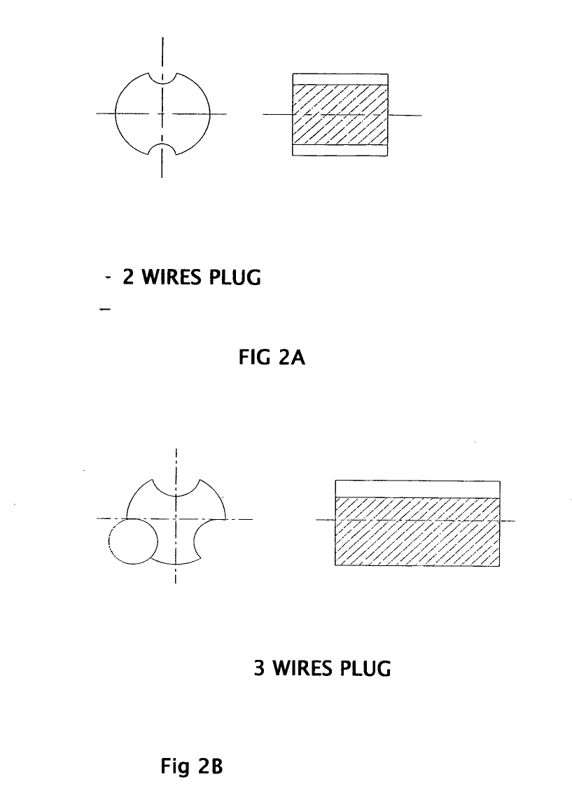

The plug 105 may be of different materials and shape. One embodiment is illustrated in FIGS. 2A and B. As shown, it is in the shape of a spool or annular ring, and it would be sized to tightly fit into the circular bottom opening of the lamp holder. Alternately it may be of any shape to correspond with the shape of the bottom opening of the lamp holder. Its material in one embodiment is an elastic material, such as plastics known in the art. In this embodiment the dimensions of the bottom opening of the lamp holder 104 and the outer perimeter of the plug 105 are such that the plug diameter is slightly larger than the diameter of the bottom opening, sufficient to create a friction or compression fit when the plug is forced into the bottom opening of the lamp holder. The elasticity of the plug allows it to be deformed and forced into the bottom opening of the lamp holder resulting in a tight pressure fit between the inner surface of the lamp holder and the outer perimeter surface of the plug when assembled. Alternatively as a second embodiment, the plug may be relatively rigid and the lamp holder could be of a material that is elastic. The plug/lamp holder seal would then occur by the stretching of the circumference of the bottom hole and its constrictive force around the plug. In the second embodiment the passageways through which the wires 106 pass would be sealed with a suitable filler, adhesive or bonding agent or method. As a further alternative where there is no compression forces the plug and lamp holder interface may be sealed with adhesive, bonding (thermal, sonic, solvent or other suitable means) or filler, and the wires sealed as above. It is contemplated that the lamp cover and lamp holder may be manufactured separately for assembly or manufactured as a single piece.

The plug fits around the electrical wires 106 and any insulation and when assembled does not interfere or damage the electrical connection of the LED pins and their respective electrical wires. In the first embodiment, in order to facilitate assembly of the plug around the wires 106, before it is inserted into the bottom opening of the lamp holder, the illustrated embodiment of the plug has a break or cut extending from the outer perimeter toward the axial center area or other desired area of the plug where the wires will be positioned. This break or cut 110 may be radial, jagged or spiral and allows the plug to be easily fitted around the wires 106, as a ring, with the wires passing through the plug from one end to the other end. Before insertion of the plug into the bottom opening, the plug in its position around the wires is moved along the wires toward the electrical connections with the pins and into the bottom opening of the lamp holder. The use of the cut or break 110 in the plug 105 of this embodiment is merely one embodiment.

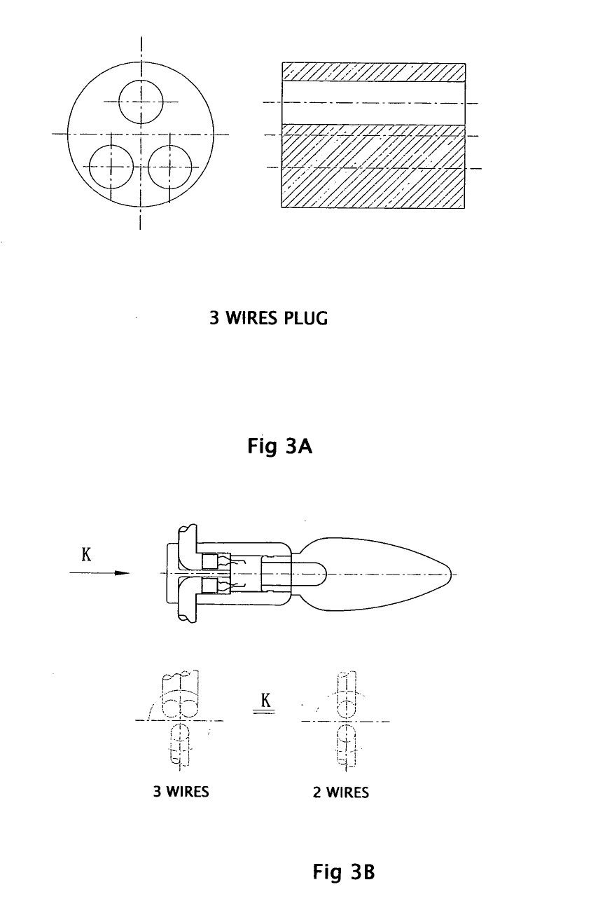

In a third embodiment, such as illustrated in FIGS. 3A and B and FIGS. 4A and B, if there is no cut or break to allow the plug to be fitted around the wires 106, the wires must be fed through the passageways in the plug before the wires are connected to the LED pins.

In the first embodiment, because the plug 105 is elastic and its diameter is slightly larger than the diameter of the bottom opening into which it is forced, the plug is deformed and compressed by the sides of the bottom opening of the lamp holder and thereby compression seals the break or cut 110 through which the plug was placed around the wires and also forms a seal around the wires and any associated insulation. Thus the plug operates to force the clip 108 to be tightly engaged with lamp holder 103. In addition the plug supports the wires and their connections with the pins.

Another alternative assembly uses a plug made of epoxy, clay, plastic, or similar material or combination known in the arts, applied to fill the bottom opening of the lamp holder and around the wire. In this embodiment the plug after being applied becomes relatively rigid due to solidifying, setting, curing or other means and thereby seals the bottom opening and the wires' passageways.

The method of assembly is as follows. At first the lamp cover and lamp holder are assembled to accomplish the seal at this connection. If the plug does not have a cut or break to allow the plug to be placed around the wires, the wires are fed through the passageways before the connections to the pins are made. The electrical connection of the pins 104 and the wires 106 are made. If a mechanical positioner or clip, such as 108, is used to support the LED body relative to the lamp cover/lamp holder subassembly, it and the diode body 102 are inserted into the lamp cover 101/lamp holder 103 subassembly. As indicated before, other means of positioning the LED may be used, including friction fit of the body of the LED with the lamp cover/lamp holder subassembly or with adhesive, epoxy or filler. Insulation may be used to inhibit short circuits. Insulation may be by any common means. With a plug without any cut or break, the assembly requires the insertion of the wires through the passageways in the plug before the electrical connection to the pins is accomplished. Final assembly is to slide the plug along the wires and into the bottom opening of the lamp holder.

If the plug is similar to FIGS. 2A and B, and thus has a cut or break 110, the connection of the LED pins and the wires can be accomplished and the LED positioned in the lamp cover/lamp holder sub-assembly before the plug is placed around the wires. Then the plug is moved along the wires and into the bottom opening of the lamp holder.

The embodiments, whether the plug, either an elastic plug, a rigid plug with an elastic lamp holder, or a plug and lamp holder that is sealed by means of bonding, sealant or filler, or by way of a plug that is epoxy or similar means is used to seal the bottom opening it further insulates and supports the wires.

The present invention provides a new LED string lamp packaging assembly structure and method that solves the manufacture problems in conventional inseparable LED lamp packaging that often damages LED bodies and wires during injection molding packaging procedures. The invented LED assembly allows theft resistance of individual LED lamps without the added costs associated with injection molding.

Packaging a LED diode body into a lamp includes these parts for achieving tight seal. At the first the lamp cover is tightly fitted, sealed, bonded or set with the top opening of the lamp holder with the LED diode positioned in the lamp cover/lamp holder by way of a tight fit, mechanical, or adhesive means with the wires that are electrically connected to the pins of the LED diode exiting the bottom opening of the lamp holder. Alternately the lamp cover/lamp holder may be formed as a single structure, equivalent to the lamp cover/lamp holder subassembly. A plug 105 is used to seal the bottom opening of the lamp cover/lamp holder/LED subassembly and seal the wires' exit from the assembly by compression, adhesive, bonding, or filler. The connection between the pins and wires can be done through soldering or mechanical means. The plug can be plastic, rubber, epoxy, clay, wood, ceramics, or combinations or other suitable means.

Different from the conventional injection molding packaging method for inseparable LED string, the present invention assembles discrete components to avoid damage to LED diodes and electric wires that can occur during the injection molding. The discrete components, including LED diodes, lamps, holders, and plug, can be manufactured independently, standardized, and replaced easily, and thus dramatically simplify the entire manufacture line and packaging procedure. The invented LED assembly and LED string packaging assembly structure and method reduce manufacture cost related to damage during injection molding, reduces the costs of special injection molding apparatus needed to accommodate individual LED or LED string configurations, does away with assembly at the site of the injection molder.

What is claimed is:

1. A new LED string lamp packaging assembly structure and design, comprising a lamp cover, a lamp holder fitted with the lamp cover, an LED diode body with pins connected to electric wires and fitted in the lamp holder and a plug around the wires and placed to seal the bottom opening of the lamp holder.

2. A method of assembling an LED string lamp packaging assembly, wherein it is assembled through the following steps: the lamp cover is fitted with the top opening of the lamp holder, the LED diode pins are electrically connected to the electric wires, the body of the LED is positioned in the lamp holder, and the plug is placed around the wires and seals the bottom opening of the lamp holder.

3. The LED string lamp packaging assembly structure of claim 1, wherein said LED lamp cover, lamp holder and body of the LED diode are tightly attached as a quasi single piece construction.

4. The LED string lamp packaging assembly structure of claim 1, wherein said LED diode is positioned in the lamp cover/lamp holder sub-assembly by way of a securing clip.

5. The LED string lamp packaging assembly structure of claim 1, wherein said plug is epoxy.

6. The LED string lamp packaging assembly structure of claim 1, wherein the plug is made of an elastic material.

7. The LED string lamp packaging assembly structure of claim 6, wherein said the size of the elastic plug is larger than the size of the bottom opening of the lamp holder.

8. The LED string lamp packaging assembly structure of claim 1, wherein said lamp holder is made of an elastic material and the plug is larger than the size of the bottom opening of the lamp holder.

9. The LED string lamp packaging assembly structure of claim 1, wherein said LED pins are connected to the electrical wires by soldering.

10. The LED string lamp packaging assembly structure of claim 1, wherein said LED pins are connected to the electrical wires by mechanical means.

11. The LED string lamp packaging assembly structure of claim 1, wherein the LED pins and their respective wires are insulated from each other.

12. The LED string lamp packaging assembly structure of claim 1, wherein said the lamp cover can be round.

13. The LED string lamp packaging assembly structure of claim 1, wherein said lamp cover can be of a polygonal shape.

14. The LED string lamp packaging assembly structure of claim 1, wherein said the LED light string may be connected to other LED light strings in parallel.

15. The LED string lamp packaging assembly structure of claim 1, wherein said the LED string can be used in low voltage circuits.

16. The LED string lamp packaging assembly structure of claim 1, wherein said the LED string can be powered by DC current.

17. The LED string lamp packaging assembly structure of claim 1, wherein said the LED string can work with an AC power supply.

18. The LED string lamp packaging assembly structure of claim 1, wherein said the wires may be entering the lamp holder through passageways in the plug.

19. The LED string lamp packaging assembly structure of claim 1, wherein said the wires may be entering the lamp holder through passageways around the plug.

20. The LED string lamp packaging assembly structure of claim 1, wherein said the wires may be entering the lamp holder through passageways between the plug and lamp holder.
